(19) United States
(12) Patent Application Publication
(10) Pub. No.: US 2007/0215007 A1
(43) Pub. Date: Sep. 20, 2007

(54) Finishing Treatment Of Pigments In Ionic Liquids

(75) Inventors: Gerald Mehltretter, Wiesbaden (DE); Hans Joachim Metz, Darmstadt (DE); Carsten Plueg, Ober-Beerbach (DE)

Correspondence Address: CLARIANT CORPORATION;INTELLECTUAL PROPERTY DEPARTMENT, 4000 MONROE ROAD, CHARLOTTE, NC, 28205, US

(73) Assignee: CLARIANT GMBH, Frankfurt am Main (DE)

(21) Appl. No.: 11/596,640

(22) PCT Filed: Apr. 28, 2005
(86) PCT No.: PCT/EP05/04541

§ 371 Date: Nov. 14, 2006

(30) Foreign Application Priority Data
May 14, 2004 (DE) 10 2004 024 000.0

(51) Int. Cl. C08K 5/00

(52) U.S. Cl. 106/493; 106/499

(57) ABSTRACT

A method for the finishing treatment of organic pigments includes allowing an, optionally milled, organic raw pigment and one or more ionic liquids to interact.

The present invention is in the field of organic colored pigments.

It is known that organic pigments, in particular azo pigments, are obtained from the synthesis solution as small insoluble particles (primary crystallites) which require an additional finishing treatment. Here, physical properties such as crystal shape, crystal size and crystal quality and also particle size distribution have to be altered in the direction of a desired optimum. If a raw pigment press cake is dried immediately after synthesis and washing, the primary particles often associate to a considerable extent to form agglomerates and aggregates. This leads to pigments which have hard particles, weak colors and display poor dispersibility and often can no longer be brought into a useable form even by milling.

Polycyclic pigments usually precipitate from the synthesis solution as coarsely crystalline raw pigments which subsequently have to be comminuted by suitable methods, e.g. milling. The prepigments obtained in this way in most cases likewise require a finishing treatment in order to achieve the desired physical properties.

The usual pigment finishing treatment is a thermal treatment in which better formation of crystals is achieved by heating the raw pigment suspension or the pigment press cake which has been washed free of salts, isolated and reslurried in water and/or organic solvents. Here, the very fine fraction which is particularly responsible for the tendency of the pigments to agglomerate is decreased and a narrower particle size distribution is consequently achieved. Particularly sparingly soluble pigments are subjected to finishing treatment in organic solvents at temperatures of from 80 to 150° C. Solvents used for this purpose are, for example, alcohols, glacial acetic acid, chlorobenzene, o-dichlorobenzene and dimethylformamide.

The finishing processes which have hitherto been customary are complicated in terms of apparatus and are energy intensive since the suspension is often heated under superatmospheric pressure and the solvent is distilled off. Since organic solvents are mostly flammable, appropriate measures to achieve plant safety have to be undertaken.

It is an object of the present invention to provide a suitable finishing process for organic pigments which is superior to the solvent finished hitherto customary in terms of safety, environmental friendliness and use of resources.

Organic salts which are liquid at temperatures of less than 100° C. are referred to as ionic liquids.

It has now been found that ionic liquids are surprisingly a suitable finishing medium for organic pigments.

The present invention therefore provides a process for the finishing treatment of organic pigments which comprises allowing the optionally milled raw organic pigment and one or more ionic liquids to act on one another.

Advantageously, the suspension of the raw pigment obtained after the pigment synthesis or after fine comminution, e.g. by milling, is filtered, washed, dried to obtain the pulverulent raw pigment and admixed with an ionic liquid or a mixture of a plurality of ionic liquids.

Instead of the dried pulverulent raw pigment, it is also possible to use a raw pigment which is moist with water or solvent, e.g. a filtercake or press cake.

The finishing treatment according to the invention is advantageously carried out in a heatable reaction vessel provided with a stirring device. The ionic liquid can be added in liquid or solid form to the raw pigment and the mixture can then be brought to a temperature above the melting point of the ionic liquid by heating. The preferred temperature range for the finishing treatment is from 25° C. to 280° C., preferably from 80 to 200° C.

Relative to the weight of the raw pigment, the ionic liquid is advantageously used in an amount (ionic liquid:pigment) of from 0.5:1 to 30:1, preferably from 1:1 to 20:1.

When raw pigment which is moist with water or solvent is used, the water or the solvent can remain in the mixture during the finishing treatment or be removed from the mixture by distillation before or during the finishing treatment.

It can be advantageous to add additional amounts of water or organic solvents, e.g. hydrocarbons, alcohols, ethers, amines, carboxylic acids, carboxylic esters or carboxamides such as N-methylpyrrolidone during the finishing treatment. The proportion of water or organic solvent can be in the range from 1 to 90% by weight, preferably in the range from 5 to 50% by weight, based on the total amount of the pigment suspension.

The duration of the finishing treatment can vary within wide limits, and is advantageously from 10 minutes to 10 hours, preferably from 30 minutes to 5 hours.

The pigment is subsequently separated off from the ionic liquid by filtration. It can be advantageous to add water or an organic solvent prior to filtration, e.g. a solvent from the group consisting of hydrocarbons, alcohols, ethers, amines, carboxylic acids, carboxylic esters and carboxamides such as N-methylpyrrolidone, in order to aid filtration. The ionic liquid can be recovered from the filtrate by extraction or by distilling off water and/or organic solvents and be reused for the finishing treatment of pigments.

The ionic liquid can be miscible or immiscible with water.

As ionic liquids, it is possible to use organic salts which have a melting point of less than 100° C. and can be described by the formula
[A]ₙ⁺[B]ⁿ⁻
where
n=1, 2 or 3 and

[B]ⁿ⁻ is an organic or inorganic anion selected from the group consisting of halide, borate, phosphate, phosphonate, antimonate, arsenate, zincate, cuprate, aluminate, carbonate, alkylcarbonate, alkylsulfonate, sulfate, alkylsulfate, alkyl ether sulfate, amide, imide, carbanion and anionic metal complexes;

[A]⁺ is a cation selected from among
ammonium cations of the formula
   [NR¹R²R³R⁴]⁺,
phosphonium cations of the formula
   [PR¹R²R³R⁴]⁺,
imidazolium cations of the formula 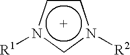
   where the imidazole ring can be substituted by at least one radical from the group consisting of C₁-C₆-alkyl, C₁-C₆-alkoxy, C₁-C₆-aminoalkyl, C₆-C₁₂-aryl or C₆-C₁₂-aryl-C₁-C₆-alkyl,
pyrrolidinium cations of the formula 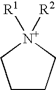
pyridinium cations of the formula 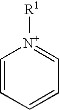
   where the pyridine ring can be substituted by at least one radical from the group consisting of C₁-C₆-alkyl, C₁-C₆-alkoxy, C₁-C₆-aminoalkyl, C₆-C₁₂-aryl or C₆-C₁₂-aryl-C₁-C₆-alkyl,
pyrazolium cations of the formula 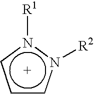
   where the pyrazole ring can be substituted by at least one radical from the group consisting of C₁-C₆-alkyl, C₁-C₆-alkoxy, C₁-C₆-aminoalkyl, C₆-C₁₂-aryl or C₆-C₁₂-aryl-C₁-C₆-alkyl,
triazolium cations of the formula 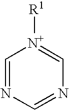
   where the triazole ring can be substituted by at least one radical from the group consisting of C₁-C₆-alkyl, C₁-C₆-alkoxy, C₁-C₆-aminoalkyl, C₆-C₁₂-aryl or C₆-C₁₂-aryl-C₁-C₆-alkyl,
guanidinium cations of the formula 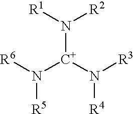
isouronium cations of the formula 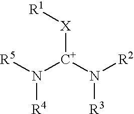
   where X is selected from the group consisting of oxygen and sulfur;
   and the radicals R¹, R² , R R⁴, R⁵, R⁶ are selected independently from the group consisting of:
hydrogen,
linear or branched, saturated or unsaturated, aliphatic or alicyclic alkyl groups having from 1 to 20 carbon atoms,
heteroaryl groups having from 3 to 8 carbon atoms in the heteroaryl radical and at least one heteroatom selected from among N, O and S which may be substituted by at least one group selected from among C₁-C₆-alkyl groups and halogen atoms;
aryl groups which have from 6 to 12 carbon atoms in the aryl radical and may be substituted by at least one C₁-C₆-alkyl group and/or a halogen atom.

Preferred anions of the ionic liquids are chloride (Cl⁻), bromide (Br⁻), tetrafluoroborate ([BF₄]⁻), tetrachloroborate ([BCl₄]⁻), tetracyanoborate ([B(CN)₄]⁻), bis[oxolato(2-)]borate ([B(OOC—CO)₂]⁻), bis[malonato(2-)]borate ([B(OOC—CH₂—COO)₂]⁻), bis[1,2-benzoldiolato(2-)-O,O′]borate ([B(O—C₆H₄—O)₂]⁻), bis[2,2′-biphenyldiolato(2-)-O,O′]borate ([B(O—C₆H₄—C₆H₄—O)₂]⁻), bis[salicylato(2-)]borate ([B(O—C₆H₄—COO)₂]⁻), hexafluorophosphate ([PF₆]⁻), tris(pentafluoroethyl)trisfluorophosphate ([(C₂F₅)₃PF₃]⁻), tris(heptafluoropropyl)trisfluorophosphate ([(C₃F₇)₃PF₃]⁻), tris(nonafluorobutyl)trisfluorophosphate ([(C₄F₉)₃PF₃]⁻), bis(pentafluoroethyl)-phosphonate ([(C₂H₅)₂P(O)O]⁻), bis(2,4,4-trimethylpentyl)phosphonate ([(C₈H₁₇)₂P(O)O]⁻), hexafluoroantimonate ([SbF₆]⁻), hexafluoroarsenate ([SbF₆]⁻), tetrachlorozincate ([ZnCl₄]⁻), dichlorocuprate ([CuCl₂]⁻), tetrachloroaluminate ([AlCl₄⁻), carbonate ([CO₃]²⁻), decanoate (C₁₀H₂₁CO₂]⁻), triflate ([CF₃SO₃⁻), nonaflate ([C₂F₅SO₃]⁻), tosylate ([CH₃—C₆H₄—SO₃]⁻), sulfate ([SO₄]²⁻), methylsulfate ([CH₃SO₄]⁻), diethylene glycol monomethyl ether sulfate ([CH₃—(OCH₂CH₂)₂—SO₄]⁻), dicyanamide ([(CN)₂N]⁻), bis(trifluoromethyl)imide ([(CF₃)₂N]⁻), bis(trifluoromethylsulfonyl)imide ([(CF₃SO₂)₂N]⁻), bis(trifluoromethylsulfonyl)methane ([(CF₃SO₂)₂CH]⁻), tris(trifluoromethylsulfonyl)-methide ([(CF₃SO₂)₃C]⁻), tetracarbonylcobaltate ([Co(CO)₄]].

Preferred organic cations of the ionic liquids are tetramethylammonium, tetraethylammonium, tetrabutylammonium, trioctylmethylammonium, 1,1-dimethylpyrrolidinium, 1-ethyl-1-methylpyrrolidinium, 1-butyl-1-methylpyrrolidinium, 1-butyl-1-ethylpyrrolidinium, 1-hexyl-1-methylpyrrolidinium, 1-octyl-1-methylpyrrolidinium, 1,1-dipropylpyrrolidinium, 1,1-dibutylpyrrolidinium, 1,1-dihexylpyrrolidinium, tetrabutylphosphonium, trihexyl(tetradecyl)phosphonium, triisobutylmethylphosphonium, benzyltriphenylphosphonium, 1-methylimidazolium, 1-butylimidazolium, 1,3-dimethylimidazolium, 1-ethyl-3-methylimidazolium, 1-butyl-3-methylimidazolium, 1-pentyl-3-methylimidazolium, 1-hexyl-3-methylimidazolium, 1-methyl-3-octylimidazolium, 1-decyl-3-methylimidazolium, 1-dodecyl-3-methylimidazolium, 1-methyl-3-tetradecylimidazolium, 1-hexadecyl-3-methylimidazolium, 1-methyl-3-octadecylimidazolium, 1-benzyl-3-methylimidazolium, 1-methyl-3-(3′-phenylpropyl)imidazolium, 1,2-dimethyl-3-propylimidazolium, 1-ethyl-2,3-dimethylimidazolium, 1-butyl-2,3-dimethylimidazolium, 1-hexyl-2,3-dimethylimidazolium, 1-hexadecyl-2,3-dimethylimidazolium, N-ethylpyridinium, N-butylpyridinium, 3-methyl-N-butylpyridinium, 4-methyl-N-butylpyridinium, 3,4-dimethyl-N-butylpyridinium, 3,5-dimethyl-N-butylpyridinium, 3-ethyl-N-butylpyridinium, N-hexylpyridinium, 3-methyl-N-hexylpyridinium, 4-methyl-N-hexylpyridinium, N-octylpyridinium, 3-methyl-N-octylpyridinium, 4-methyl-N-octylpyridinium, diethylpyrazolium, ethyltriazolium, guanidinium, N,N,N′,N′-tetramethyl-N″-ethylguanidinium, N-pentamethyl-N-isopropylguanidinium, N-pentamethyl-N-propylguanidinium, hexamethylguanidinium, O-methyl-N,N,N′,N′-tetramethylisouronium, O-ethyl-N,N,N′,N′-tetramethylisouronium, S-ethyl-N,N,N′,N′-tetramethylisothiouronium.

The finishing treatment according to the invention can be carried out on all organic colored pigments such as azo pigments and polycyclic pigments. Azo pigments can be monoazo pigments, disazo pigments, disazo condensation pigments, naphthol pigments or metal complex pigments.

Suitable azo pigments are, in particular, C.I. Pigment Yellow 16, 32, 83, 97, 120, 151, 154, 155, 175, 180, 181, 191, 194, 213, Pigment Orange 34, 36, 38, 62, 72, 74, Pigment Red 53:2, 112, 122, 137, 144,170, 171, 175, 176, 185, 187, 188, 208, 214, 242, 247, 253; Pigment Violet 32; Pigment Brown 25.

Polycyclic pigments can be, for example, isoindolinone pigments, isoindoline pigments, anthanthrone pigments, thioindigo pigments, quinophthalone pigments, anthraquinone pigments, dioxazine pigments, phthalocyanine pigments, quinacridone pigments, perylene pigments, perinone pigments, diketopyrrolopyrrole pigments, thiazinindigo pigments and azomethine pigments, in particular Pigment Violet 19, 23, Pigment Blue 15, Pigment Green 7, 36, 37, Pigment Red 122, 179, 202, 254, Pigment Yellow 139.

It has been found that the finishing treatment according to the invention can replace the aqueous or solvent finish which has hitherto been customary. Furthermore, further physical properties, e.g. the crystal modification or the ratio of crystal modifications formed, can surprisingly also be altered in the case of some pigments, as a function of temperature, pressure, treatment time and addition of water.

Thus, for example, raw P.R. 170 in the a phase is converted by the finishing treatment according to the invention into a P.R. 170 in the β phase or the γ phase or a mixture of the β phase and the γ phase.

Analogously, for example, raw P.Y. 213 in the β phase is converted by the finishing treatment according to the invention into a P.Y 213 in the α phase. In the following examples, the color properties of the pigment samples obtained were determined in alkyd-melamine stoving enamel AM 5 by means of comparative measurements; the untreated samples served as reference in each case.

The valuation of the brightening was carried out by calorimetric measurement according to the CIELAB system in accordance with DIN 6174; measurements were carried out on a Gardner PCM instrument and the mean of three individual values was formed in each case. Evaluation of the full ton was carried out visually under a color matching lamp in accordance with ASTM D1729 using daylight (CIE D65).

The determination of the crystal modification of the pigments obtained was carried out by means of X-ray powder diffractometry.

The following ionic liquids were used.

| Name | Cation | Anion |
|---|---|---|
| ®ECOENG 41M ¹⁾ | Butylmethylimidazolium | Diethylene glycol |
| | | monomethyl |
| | | ether sulfate |
| [BMIM][PF₆] ¹⁾ | Butylmethylimidazolium | Tetrafluoroborate |
| ®CYPHOS 3653 ²⁾ | Trihexyltetra- | Chloride |
| | decylphosphonium | |

¹⁾ from Solvent Innovation
²⁾ from Cytec

### EXAMPLES 1 to 4

### Finishing of P.R. 170 (Dried Pigment) using ECOENG 41M

22.7 g of raw P.R. 170 pigment (powder, α phase) were mixed with 200 ml of ECOENG 41M in a 2 I flask and stirred at RT for 30 minutes. The mixture was heated to 120° C. over a period of 10 minutes and stirred at this temperature for 2 hours. The mixture was then admixed with 200 ml of water, filtered hot and washed with 1200 ml of water. The pigment press cake was dried at 100° C. for 16 hours, giving 22.3 g of P.R. 170 as a mixture of the β phase and the γ phase (ratio about 95:5).

The filtrate was filtered through Celite and activated carbon and the water was subsequently distilled off in order to recover the ionic liquid.

The finishing conditions were varied according to the following table:

| | Finishing | | | | | |
|---|---|---|---|---|---|---|
| Ex. | conditions | | Finishing | | | |
| No. | t [h] | T [° C.] | medium | Crystal phase | Color shade*⁾ | Covering power |
| 1 | 2 | 120 | ECOENG 41M | 95% beta, | Slightly | Slightly greater |
| | | | | 5% gamma | yellower | covering power |
| 2 | 2 | 150 | ECOENG 41M | 70% beta, | Slightly | Slightly greater |
| | | | | 30% gamma | yellower | covering power |
| 3 | 0.5 | 160 | ECOENG 41M | 50% beta | Distinctly | Significantly |
| | | | | 50% gamma | yellower | greater |
| | | | | | | covering power |
| 4 | 2 | 170 | ECOENG 41M | 10% beta | Distinctly | Somewhat |
| | | | | 90% gamma | yellower | greater |
| | | | | | | covering power |

*⁾Compared to P.R. 170, 100% beta phase

### EXAMPLE 5

### Finishing of P.R. 170 (Moist Press Cake) using ECOENG 41M

The procedure of Example 1 was repeated using 136 g of P. R. 170 raw pigment as press cake moist with water (alpha phase) instead of the dried raw pigment. The mixture of raw pigment, ECOENG 41M and water was heated to 110° C. over a period of 10 minutes and stirred at this temperature for 30 minutes. During this time, the water was kept in the mixer by means of a reflux condenser. A work-up analogous to Example 1 gave 22.3 g of P.R. 170 in the beta phase.

### EXAMPLE 6

### Finishing of P.R. 170 (Dry Pigment) using [BMIM][PF₆]

procedure of Example 1 was repeated, but 200 ml of ECOENG 41MTM ad of 200 ml of [BMIM][PF₆] were used and the mixture was heated at 150° C. hours. This gives 22.5 g of P.R. 170 in the beta phase.

### EXAMPLE 7

### Finishing of P.R. 170 (Dry Pigment) using CYPHOS 3653

The procedure of Example 6 was repeated using 200 ml of CYPHOS 3653 instead of 200 ml of [BMIM][PF₆]. This gives 22.4 g of P.R. 170 in the beta phase. For the purposes of the present invention, the alpha phase of P.R. 170 is the crystal modification characterized by the following characteristic lines in the X-ray powder diffraction pattern (Cu—K_{α} radiation, 2Θ values in degrees): 7.6 (strong), 25.7 (strong), 5.2, 8.2, 11.7, 13.5, 15.9, 18.9, 23.5 (all medium).

For the purposes of the present invention, the beta phase is the crystal modification of P.R. 170 characterized by the following characteristic lines in the X-ray powder diffraction pattern: 25.5 (strong), 7.1, 8.2, 11.3, 12.8, 15.1, 17.9 (all weak).

The gamma phase is characterized by the following lines: 25.7 (strong), 7.3, 11.3, 12.9, 15.4, 18.2 (all medium).

All line positions of all modifications of all pigments have an accuracy of ±0.2°.

### EXAMPLE 8

### Finishing of P.Y. 213 (Dry Pigment) using ECOENG 41M

The procedure of Example 1 was repeated, but P.Y. 213 (powder, beta phase) was used instead of P. R. 170 and the mixture was heated at 150° C. for 2 hours.

This gives 22.5 g of P. Y. 213 in the alpha phase.

The pigment formed by the finishing treatment is distinguished from the untreated form (brown color shade) by a brilliant yellow color shade.

### EXAMPLE 9

### Finishing of Copper Phthalocyanine (Raw Blue) using ECOENG 41M

The procedure of Example 1 was repeated, but 25 g of copper phthalocyanine (raw blue) were used instead of P.R. 170 and the mixture was heated at 130° C. for 3 hours. This gives 24.4 g of copper phthalocyanine in the beta phase.

The pigment formed by the finishing treatment is distinguished from the untreated form (dull blue) by a brilliant greenish blue color shade.

### EXAMPLE 10

### Finishing of Copper Phthalocyanine (Raw Blue) using CYPHOS 3653

The procedure of Example 9 was repeated using CYPHOS 3653 instead of ECOENG 41M. This gives 21.7 g of copper phthalocyanine in the beta phase as a brilliant greenish blue pigment.

1. A process for the finishing treatment of a raw organic pigment comprising the step of allowing the raw organic pigment and one or more ionic liquids to act on one another, wherein the raw organic pigment is optionally milled.

2. The process as claimed in claim 1, wherein the one or more ionic liquids have the formula
[A]ₙ⁺[B]ⁿ⁻
wherein
n=1, 2 or 3 and
[B]ⁿ⁻ is an organic or inorganic anion selected from the group consisting of halide, borate, phosphate, phosphonate, antimonate, arsenate, zincate, cuprate, aluminate, carbonate, alkylcarbonate, alkylsulfonate, sulfate, alkylsulfate, alkyl ether sulfate, amide, imide, carbanion and anionic metal complexes;
[A]⁺ is a cation selected from the group consisting of
ammonium cations of the formula
[NR¹R²R³R⁴]⁺,
phosphonium cations of the formula
[PR¹R²R³R⁴]⁺,
imidazolium cations of the formula 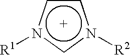
where the imidazole ring is optionally substituted by at least one radical selected from the group consisting of C₁-C₆-alkyl, C₁-C₆-alkoxy, C₁-C₆-aminoalkyl, C₆-C₁₂-aryl and C₆-C₁₂-aryl-C₁-C₆-alkyl,
pyrrolidinium cations of the formula 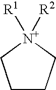
pyridinium cations of the formula 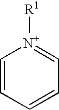
where the pyridine ring can be is optionally substituted by at least one radical from the group consisting of C₁-C₆-alkyl, C₁-C₆-alkoxy, C₁-C₆-aminoalkyl, C₆-C₁₂-aryl and C₆-C₁₂-aryl-C₁-C₆-alkyl,
pyrazolium cations of the formula 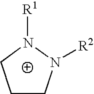
where the pyrazole ring is optional substituted by at least one radical selected from the group consisting of C₁-C₆-alkyl, C₁-C₆-alkoxy, C₁-C₆-aminoalkyl, C₆-C₁₂-aryl and C₆-C₁₂-aryl-C₁-C₆-alkyl,
triazolium cations of the formula 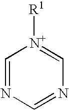
where the triazole ring is optionally substituted by at least one radical selected from the group consisting of C₁-C₆-alkyl, C₁-C₆-alkoxy, C₁-C₆-aminoalkyl, C₆-C₁₂-aryl and C₆-C₁₂-aryl-C₁-C₆-alkyl,
guanidinium cations of the formula and 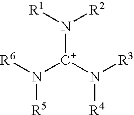
isouronium cations of the formula 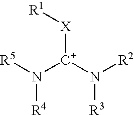
wherein X is selected from the group consisting of oxygen and sulfur; and the radicals R¹, R², R³, R⁴, R⁵, R⁶ are, independently of one another, selected from the group consisting of:
hydrogen,
linear or branched, saturated or unsaturated, aliphatic or alicyclic alkyl groups having from 1 to 20 carbon atoms,
heteroaryl groups having from 3 to 8 carbon atoms in the heteroaryl radical and at least one heteroatom selected from among N, O and S optionally substituted by at least one group selected from the group consisting of C₁-C₆-alkyl groups and halogen atoms; and
aryl groups which have from 6 to 12 carbon atoms in the aryl radical optionally substituted by at least one C₁-C₆-alkyl group or a halogen atom.

3. The process as claimed in claim 1, wherein the raw organic pigment is in the form of a powder, filtercake or press cake.

4. The process as claimed in claim 1, wherein the process is carried out at a temperature in the range from 25 to 280° C.

5. The process as claimed in claim 1, wherein the process is carried out at a temperature in the range from 80 to 200° C.

6. The process as claimed in claim 1, wherein the weight ratio of one or more ionic liquid: raw organic pigment is in the range from 0.5:1 to 30:1.

7. The process as claimed in claim 1, wherein the duration of the process is from 10 minutes to 10 hours.

8. The process as claimed in claim 1, wherein the process is carried out in the presence of water or an organic solvent.

9. The process as claimed in claim 8, wherein the amount of water or organic solvent is from 1 to 90% by weight, based on the total amount of the raw organic pigment and one or more ionic liquids.

10. The process as claimed in claim 1, wherein the raw organic pigment is an azo pigment or a polycyclic pigment.

11. The process as claimed in claim 1, wherein the raw organic pigment is milled.
